(19) United States
(12) Patent Application Publication
(10) Pub. No.: US 2015/0181910 A1
(43) Pub. Date: Jul. 2, 2015

(54) SOLID ANIMAL SUPPLEMENTS AND METHODS FOR MAKING THEM

(71) Applicant: A.A. Company Pty Ltd., Milton, QL (AU)

(72) Inventors: Martin Fullagar, Comet (AU); Cameron Bruce Best, Tarragindi (AU)

(73) Assignee: A.A. Company Pty Ltd., Milton (AU)

(21) Appl. No.: 14/418,541

(22) PCT Filed: Jun. 7, 2013
(86) PCT No.: PCT/AU2013/000607

§ 371 Date: Jan. 30, 2015

(30) Foreign Application Priority Data
Jul. 31, 2012 (AU) 2012903273

(51) Int. Cl. A23K 1/02; A23P 1/10; A23K 1/175; A23K 1/16; A23K 1/18; A23K 1/22

(52) U.S. Cl. CPC A23K 1/02; A23K 1/1813; A23K 1/22; A23K 1/175; A23K 1/1634; A23K 1/1755; A23P 1/105

(57) ABSTRACT

The present invention relates to solid animal supplement blocks that have high nutritional values and processes for their manufacture. The solid feed blocks comprise Condensed Molasses Solubles (CMS), a source of phosphorous and a liquid source. The solid feed blocks are suitable for use with rangeland animals.

### FIELD OF THE INVENTION

The present invention relates to solid animal supplement blocks that have high nutritional values. The solid animal supplements are suitable for use with rangeland animals. Processes for manufacturing the supplement blocks are also disclosed.

### BACKGROUND OF THE INVENTION

Supplement blocks are known and manufactured to produce minerals and nutrition for rangeland animals such as cattle. Such supplement blocks are particularly useful in times of drought when adequate nutrition is difficult to obtain. Supplement blocks can be important in managing pasture budgeting and animal nutrition.

A rangeland pasture goes through four stages, being: young leaves, early flowering, full flowering and seed drop and leaf decline (MLA 2012 Pasture and Grazing Management for Weaners, p. 3). Rangeland pasture is in leaf decline stage for most of the dry season, presenting an array of nutritional deficiencies in energy, protein phosphorus and key macro minerals such as potassium and sulfur.

A decrease in animal intake is correlated with reduced digestibility of rangeland plants. Animal intake, and therefore energy supply, can be stimulated in these situations with the supplementation of nitrogen.

Nitrogen loss occurs due to leaf decline and senesces in the rangeland plants as they mature.

Phosphorus content in plants also decreases with increasing maturity as phosphorus is continually transferred to new growth. Furthermore, tropical pasture has lower phosphorus content because soils are often lower in phosphate, the use of fertilizer uneconomic and plants mature and reach senesence more rapidly than temperate species (Norton, 1982, Nutritional Limits to Animal Production from Pastures, Farnham Royal U.K., 133-150). In grazing livestock, phosphorus deficiency is the most prevalent mineral deficiency throughout the world.

As pasture matures, the amount of nutrients available to rangeland grazing animals decreases. For example, potassium content of pasture decreases as pasture matures and during the winter season. Potassium is important for healthy cattle and potassium deficiency results in reduced feed intake, reduced weight gain, pica, rough hair coat and muscular weakness (Devlin et al. J. Animal Science, 1969, 28, 557-562). Gestating cows and lactating cows require higher amounts of potassium as there is a relatively high secretion of potassium in cows milk (1.5 g/kg) (Clanton, 1980, Proceedings, Third International Mineral Conference, January 17-18, Miami, Fla.).

The activity of ruminal micro-organisms, including fungi, is impaired when there is an insufficiency of sulfur, even when there is adequate nitrogen present from rumen degradable protein (Akin and Hogan, Crop Sci., 1985, 23, 851-858).

There are a number of supplement blocks produced commercially but these products have drawbacks in relation to the amount of nutrition supplied, a lack of variability in components and expense of manufacture.

Salt press blocks have low nutritional density and must have uniform component particulate size. High pressure is also required during manufacture and therefore the manufacturing process uses significant energy.

Hot urea and molasses blocks require the heating of molasses to 80° C. and are therefore expensive to manufacture. Although these blocks provide satisfactory nutritional content, it is not possible to vary the components significantly.

Cold urea and molasses blocks are made by a lower energy process than for hot urea and molasses blocks but again very little variation in components is tolerated.

All of these blocks are limited by the type and amount of phosphate that can be used. Salt press blocks have limited nutritional space, so additional phosphate is added at the expense of other essential nutrients such as protein. The inclusion of phosphate in urea and molasses blocks is an exacting art having little tolerance in quality and quantity.

An alternative is loose licks which are dry mixed and nutritionally dense. However, it is difficult to manage intake of loose licks and often animal intake is highly variable.

An emerging. difficulty with molasses-containing blocks is that molasses is increasingly being used as seed stock in the production of ethanol and amino acids such as glutaric acid. However, the residual product from fermentation of molasses, condensed molasses solubles (CMS) is available and may be used in supplement blocks and loose licks.

CMS has been used in supplement blocks together with a phosphorus source. The block is produced in an expensive process requiring both pressure and steam.

There is a need for supplement blocks that are easily manufactured by low energy processes and that have high nutritional value, including sources of phosphorus, nitrogen, potassium and sulfur and in which components can be varied to deliver diverse nutritional or energy content.

### SUMMARY OF THE INVENTION

The present invention is predicated in part on the discovery that a high nutrition solid supplement block may be produced by a simple method of mixing, moulding and pressure using CMS and a phosphorus source.

### BRIEF DESCRIPTION OF THE DRAWINGS

An example of the present invention will now be described with reference to the accompanying drawings, in which:

FIG. 1 shows a schematic perspective view representation of an example of a solid feed block;

FIG. 2 shows a schematic plan view representation of the solid feed block of FIG. 1;

FIG. 3 shows a schematic side view representation of the solid feed block of FIG. 1;

FIG. 4 shows a schematic perspective view representation of the solid feed block of FIG. 1 in use; and,

FIG. 5 shows a schematic perspective view representation of the solid feed block of FIG. 4 in a partially consumed state.

### DESCRIPTION OF THE INVENTION

In one aspect of the invention there is provided a solid feed block comprising:
i) Condensed Molasses Solubles (CMS),
ii) a source of phosphorus, and
iii) a liquid source.

The CMS used is in solid form and may be a powder or may be granular. In particular embodiments, the CMS is in granular form. When the CMS is in granular form, the average granule size is between 1 and 10 mm, especially 1 to 5 mm, more especially 2 to 4 mm. In some embodiments, at least 80% of the granules are between 2 and 4 mm, especially at least 85%, more especially at least 90%.

The CMS may contain at least 30% w/w crude protein, especially at least 35% w/w, more especially at least 40% w/w. By “crude protein” is meant sources of nitrogen including amino acids ammonium ions, urea and nitrate. In some embodiments, the CMS comprises at least 50%, especially at least 60% w/w crude protein. In some embodiments, about 14% to about 20% w/w of the crude protein is amino acids.

In some embodiments, the CMS comprises trace elements, especially potassium, sodium, magnesium and/or sulfur. Potassium may be present in an amount in the range of 2% to 4% w/w of the CMS, especially about 3% w/w. Sodium may be present in the range of 1% to 3% w/w, especially about 1.5% w/w, magnesium may be present in the range of 0.1 to 1% w/w, especially about 0.5% w/w. Sulfur may be present in an amount in the range of 1.5% to 3% w/w of the CMS, especially 2% to 2.5% w/w.

In a particular embodiment, the CMS is glutamic acid CMS (GA-CMS) derived from the fermentation of molasses in the manufacture of glutamic acid. In some embodiments, the crude GA-CMS obtained as a byproduct of the fermentation is further treated to form pellets. The CMS is treated with acid, such as sulphuric acid, to hydrolyze proteins present in the crude CMS to provide amino acids, heat for the hydrolysis may be provided by steam. After cooling this hydrolysis product, the product is neutralized by addition of a base, such as ammonia, to give a pH of 5-6. The neutralized product is dried using hot air and formed into granules. Optionally, if a minimum granule size is required, smaller granules) may be removed by sieving.

The CMS is present in the supplement block in an amount in the range of about 66% to about 94% w/w of the feed block, especially about 70% to 90% w/w, more especially about 75% to 85% w/w, most especially about 78% to about 82% w/w of the feed block.

The source of phosphorus is a high quality source of phosphorus and is in solid form. The source of phosphorus comprises at least 16% by weight phosphorus and may contain calcium, sodium and/or magnesium. In particular embodiments, the source of phosphorus is selected from monosodium phosphate, monocalcium phosphate (MCP), monodicalcium phosphate (MDCP), dicalcium phosphate (DCP) in dihydrate or anhydrous form, and tricalcium phosphate (TCP). In particular embodiments, the source of phosphorus is MDCP, for example, products sold under the trade names Kynofos® and Biofos®.

The source of phosphorus is present in the solid supplement block in an amount in the range of about 3% to 17% w/w of the feed block, especially about 6% to 14% w/w, more especially 9% to 11% w/w of the feed block.

The source of liquid may be any aqueous liquid, for example, water or a syrup obtained from a plant, for example, sorghum syrup, molasses, or corn syrup. The use of syrup adds carbohydrates and protein to the supplement block. In a particular embodiment, the aqueous liquid is water.

The liquid source is present in the supplement block in an amount of about 3% to about 20% w/w of the supplement block. If the liquid source is water, the water is present in an amount in the range of about 3% to about 17% w/w of the supplement block, especially about 6% to 14% w/w, more especially about 9% to 11% w/w. If a syrup is used, the amount used will depend on the solids content of the syrup. The amount of liquid is increased to compensate for the solid content, for example 6% to 20% w/w, 9% to 17% w/w or especially 11% to 14% w/w.

In particular embodiments, the supplement block further comprises a surfactant with an

Hydrophilic Lipophilic Balance (HLB) of between 4 and 11 and is suitable for consumption by rangeland animals. In some embodiments, the surfactant is a non-ionic surfactant such as a polysorbate or ethoxylate surfactant. Suitable surfactants include polyoxyethylene sorbitan monooleate (Tween®80) or other Tween® or Span® surfactants such as SPAN®20, Tween®85, Tween®65, and SPAN®80. In a particular embodiment, the surfactant has an HLB between 8 and 9, especially about 8.6, for example, polyoxyethylene sorbitan monooleate. In one embodiment, the surfactant is a molasses surfactant. In some embodiments, the surfactant composition includes other components such as low molecular weight carboxylic acids and diols, for example sorbic acid, acetic acid, lactic acid, propionic acid, ammonium propionate, L-ascorbic acid, citric acid and 1,2-propane diol. A particularly useful surfactant is sold under the trade name SELKO®-FLOW. The purpose of the surfactant is to assist with mixing during the making of the animal supplement block. The surfactant is present in an amount in the range of about 0.15% to about 0.7% w/w of the supplement block, especially about 0.25% to 0.4% w/w.

Additional components may be incorporated in the supplement block, for example, further nutritional additives such as cereals, starchy meals, fats, especially solid fats, antioxidants, protein meals, non-protein nitrogen sources, vitamins, trace minerals, medicaments, rumen modifiers and anti-methanogenic compounds.

Suitable cereals include but are not limited to corn, wheat, rye, oats, barley, rice, millet, sorghum, triticale and buckwheat. Suitable starchy meals include but are not limited to meals of any of the above mentioned cereals, and potato derived meals such as chip meal. Suitable fats include but are not limited to edible fats from animal and vegetable sources especially solid fats including palm derived C₁₆ and C₁₈ fatty acids, coconut derived fatty acids, tallow, hydrogenated tallow, and the like. In particular embodiments, rumen protected fats are used such as those sold under the brand names Golden Flake®, Morlac® and Magna Pac®.

Suitable protein meals provide peptides and amino acids. Examples include but are not limited to cottonseed meal, sunflower meal, copra meal, linseed meal, soya bean meal, peanut meal and canola meal.

Suitable non-protein nitrogen sources include, but are not limited to, urea, biuret, ammonium compounds such as ammonium nitrate and ammonium polyphosphate, and nitrates such as potassium nitrate, sodium nitrate and calcium nitrate.

The supplement block may be supplemented with one of the further nutritional additives referred to above by reducing the weight % of CMS and replacing it with the additive. The additive may be present in an amount in the range of about 3% to 7% w/w of the supplement block. In some embodiments, where a solid fat is used, an antioxidant may be included to reduce oxidation degradation of the fats. Suitable antioxidants include butylated hydroxyanisole, butylated hydroxytoluene, 4-hydroxymethyl-2-phenol or 6-ditert-butyl-phenol and the like. The antioxidant may be present in the range of 0.01% to 1% w/w of the fat component.

Rumen modifiers beneficially alter the balance between different microbes in the rumen and the proportions of volatile fatty acids, such as propionic acid, the bacteria produce. Suitable rumen modifiers are ionophores such as monensin, tylosin, salinomycin, lasalocid and bambermycin, especially monensin, salinomycin and lasalocid. The rumen modifier may be used in accordance with their registered use. For example, monensin is sold under the brand name Rumensin 100® and is used in an amount in the range of 0.3% to 1.5% as per its product registration.

Anti-methanogenic compounds reduce the amount of methane produced by the livestock. Suitable anti-methanogenic compounds include tannins, plant based oils and monensin. The anti-methogenic compound may be present in an amount up to 30% w/w of the supplement.

The supplement feed block may be made to any size suitable for the location it is to be used, for example, 10 kg to 1000 kg. The size of the block may depend on the number of rangeland animals that will have access to the block, the location of the block, for example, remote areas on large range or in a paddock on a smaller farm, the accessibility of the location and the equipment required to move the block to the required location. In particular embodiments, the size of the solid feed block is between 10 kg and 200 kg, especially 20 kg to 200 kg, 20 kg to 150 kg or 20 kg to 100 kg. In some embodiments, the solid feed block is between 20 kg and 50 kg, especially about 30 kg in size. In another particular embodiment, the size of the solid feed block is about 150 kg.

The supplement block may be any suitable shape and this may depend on the mould used. For example, if the mould is a bag or sack the block will be shaped dependent on the fullness of the bag or sack used. The supplement block may be any three dimensional shape such as a cube, a rectangular prism, a hexagonal prism, a triangular prism, a cylinder, a sphere and the like.

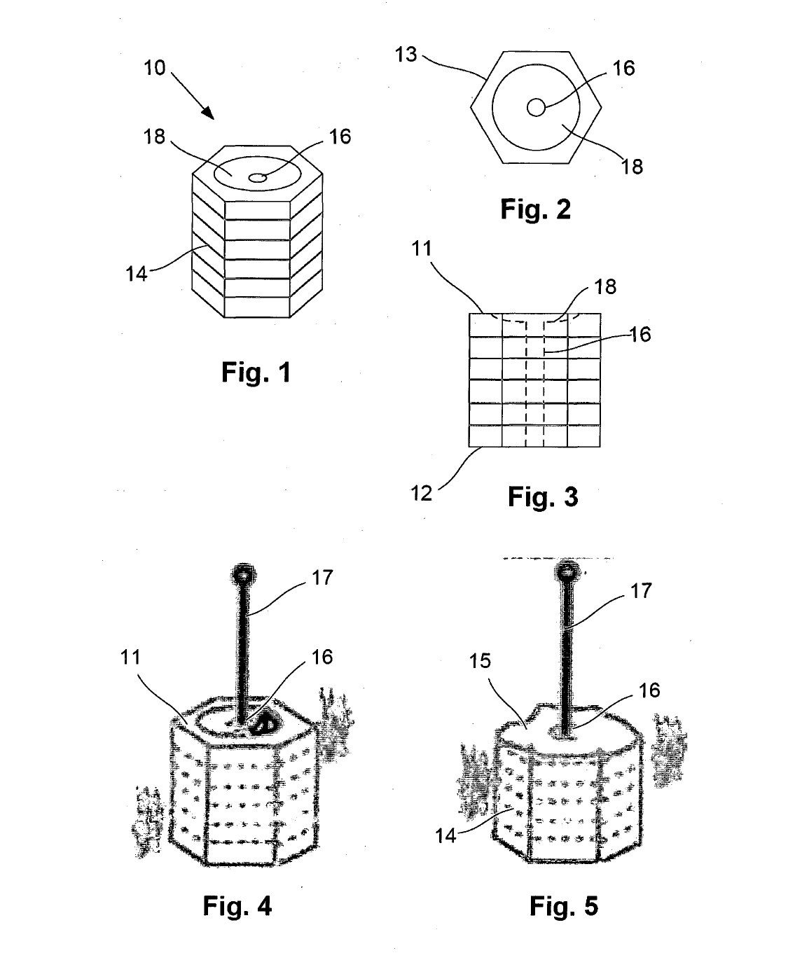

An example embodiment of a solid supplement block 10 is shown in FIGS. 1 to 5, and will be referred to throughout the following discussion of optional features regarding the shape of the block.

In some embodiments, the solid supplement block is moulded to a suitable shape for stacking. For example, the solid supplement block may be moulded to have top and bottom surfaces which substantially conform to one another, to thereby enable stable stacking on top of another block.

In one embodiment, the top and bottom surfaces may each be substantially planar, but it will be appreciated that other surface configurations may be used, such as by forming the top and bottom surfaces to have complimentary concave and convex profiles. In some embodiments, the supplement block may have ridges on the top or bottom surface that are complementary to channels in the bottom or top surface of another block to facilitate stable stacking. As can be seen in FIG. 3, the example block 10 has generally flat top and bottom surfaces.

In some embodiments, the shape of the solid supplement block includes at least one substantially planar side surface. This can allow the supplement feed block to rest on the substantially planar side surface during transport, and may help to prevent unintended rolling in a truck bed or the like. It will be appreciated that substantially planar side surfaces may be provided by forming the solid supplement block to have a cross section of a regular polygon, such as a square, hexagon, octagon etc.

In one example, the solid supplement block may have a cross section of a regular polygon having greater than four sides to promote handling by pushing/pulling the solid supplement block and causing it to roll from its normally stationary position resting on one of its substantially planar sides. The example block 10 has a generally hexagonal cross section with six substantially planar sides 13 as best seen in FIG. 2.

In some embodiments, the shape of the solid supplement block includes consumption rings located on the surface, especially on the sides, of the block (see consumption rings 14 of the depicted example block 10). In one example the consumption rings may be provided by having protruding ridges or the like on inner surfaces of the mould. The purpose of consumption rings is to allow an assessment of the rate of consumption of the block. FIG. 5 shows an example of a partially consumed block 10, in which a visual indication of the amount of the block 10 that has been consumed can be determined by comparison of the position of the remaining upper surface 15 against the consumption rings 14. In some embodiments, the shape of the block inherently allows assessment of consumption, for example, the ridges and channels that may be present to assist with stacking.

In some embodiments, the block includes an aperture that extends through the block between the top and bottom surfaces. The aperture may be centrally located within the block, as per the example aperture 16 in FIGS. 1 to 5. The aperture may be any shape, for example, circular or square, and may be chosen to suit equipment used for handling, accessibility and measurement equipment. For example, the aperture may allow the use of poles, crowbars, jib arrangements and the like to provide ease of handling from storage to transport and transport to location of use. For example, the aperture may allow distribution via Hiab crane located on a truck. The aperture may also allow installation of recording or monitoring devices that monitor the number of animals visiting the block and consumption allowing a manager to assess effectiveness of the supplement blocks and locations of the feed blocks. For example, the aperture may be used to house a pole or post on which a National Livestock Identification System (NILS) recorder is located.

In some embodiments, the aperture may also assist in drainage of rain water from the surface of the block preventing dissolution of block components which may concentrate in the water and be detrimental to the rangeland animals. For example, soluble nitrogen containing compounds may concentrate in undrained water and additional drainage reduces the risk of livestock nitrate poisoning. In some embodiments, such as the example block 10 shown in FIGS. 1 to 4, the top surface 11 may include an inwardly sloping depression 18 that channels rainwater towards a centrally located aperture 16, thus improving drainage.

As shown in FIGS. 4 and 5, some embodiments of the block may be held in place for consumption by using the aperture 16 to mount the block on an upright post 17 or the like.

In some embodiments, the aperture may be used to suspend a block or blocks above the ground surface, for example, on a pole located transversely at a suitable elevation from the ground surface. Such a pole may extend between supports such as upright posts or the like. The feed block or blocks may then be more visible to the livestock and may be located at a suitable height for the rangeland animals to use. In this embodiment, optionally a wire mesh tray may also be suspended at an elevation between the blocks and the ground to prevent pieces of block from falling on the ground and allow drainage around the pieces. This embodiment may also allow visual assessment of consumption.

The solid supplement blocks are suitable for rangeland animals including, but not limited to, cattle, sheep, goats, deer, elk, antelope, buffalo and bison, especially cattle.

In another aspect of the present invention there is provided a process for the manufacture of solid supplement blocks comprising the steps of:
i) adding CMS, a source of phosphorus and a liquid source to a mixing container;
ii) mixing the components from step i) for a time sufficient to obtain homogeneous wetting of the dry components;
iii) transferring the mixture obtained in step ii) to a mould; and
iv) allowing the mixture to harden.

The mixing may be achieved by any type of known mixing that will achieve homogenous wetting of the components. For example, the mixing may be done by hand or by machine. High shear mixing is not required. The type of mixing will determine the length of time required to achieve homogenous mixing. For example mixing by hand will take longer than mixing in a machine.

By “homogenous wetting” or “homogenous mixing” is meant that the liquid components of the mixture are mixed throughout the dry components as assessed visually. Visual assessment includes the mixture exhibiting shiny properties but not to the point of being a slurry. Homogenous wetness does not mean that small pockets of dry components that do not come into contact with liquid do not exist, however, any such pockets are not visible upon visual inspection.

Optional additives may be added in step i) with the CMS, source of phosphorus and liquid source. Alternatively the optional additives may be added during mixing. In some embodiments, steps i) and ii) are performed together and the components and optional additives are added while mixing occurs. In some embodiments, when a surfactant is present, the surfactant is added with the liquid source. In other embodiments, the surfactant is added after the liquid source.

After mixing, the mixture is transferred to a mould. This transfer may occur by any suitable means, such as shovelling, tipping, decanting, pouring or pumping.

Any suitable mould may be used to achieve the desired size and shape of the block. In some embodiments, the mould may be a mesh bag that holds 10-50 kg, especially about 30 kg, of mixture. In other embodiments, the mould may be a cardboard box or cardboard mould in a desired shape. In yet other embodiments, the mould may be a metal or plastic mould. The type of mould used may be determined by the pressure that is to be applied during hardening, mesh and cardboard moulds may be suitable when no pressure or low pressure is used, plastic and especially metal moulds, may be used when higher pressures are used during hardening.

The length of time taken for hardening to occur will depend on the pressure applied to the mould during hardening. If no pressure is applied, the mixture is left until a desired degree of hardness is obtained. In particular embodiments, particularly, where the mould is a mesh bag or made of cardboard, the moulds may be stacked on top of each other applying low pressure, for example, 1:1, 2:1, 3:1, 4:1, 5:1 pressure, for example, a 30 kg bag stacked with 1, 2, 3, 4 or 5, 30 kg bags on top. In a stack of three, the bottom 30 kg bag will have 60 kg on top therefore will have 2:1 pressure, the middle bag will have 30 kg on top and therefore 1:1 pressure and the top bag will have no pressure on top. Optionally during hardening the bags or moulds may be moved in position in the stack so that each mould is exposed to an average of 1:1 pressure. The hardening process may take 1 to 5 days using this type of pressure, especially 2 to 3 days.

In one example, conforming top and bottom surfaces of the solid feed blocks as discussed above may be formed as a result of using relatively compliant thin-walled moulds such as bags or sacks and stacking the solid feed blocks during hardening.

In some embodiments, the mould is exposed to higher pressure, for example, in a conventional dry press. Typical presses have three parts, a top pressing plate, a bottom pressing plate and the sides. The three parts are detachable to allow removal of the pressed block. The mould may be exposed to pressure, for example, up to 1000 psi, for a time sufficient to result in the desired hardening. For example, at 1000 psi, about 3 seconds is required to obtain the desired hardening. Varying the pressure between 0 and 1000 psi varies the time required for hardening. For example, the higher the pressure the less time required for hardening.

The hardness of the resulting block may be measured by assessing the amount of pressure that may be applied to a given surface area. For example, the blocks have a minimum hardness of 80 units when hardness is measured with a CF Durometer (for example, PTC414CF) with a force of 9.11 kgf, especially at least 85 units, and more especially ≦90 units.

The articles “a” and “an” are used herein to refer to one or to more than one (i.e. to at least one) of the grammatical object of the article. By way of example, “an element” means one element or more than one element.

As used herein, the term “about” refers to a quantity, level, value, dimension, size, or amount that varies by as much as 30%, 25%, 20%, 15% or 10% to a reference quantity, level, value, dimension, size, or amount.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

This invention will now be described with reference to the following examples which illustrate some preferred aspects of the invention. However, it is to be understood that the particularity of the following description of the invention is not to supersede the generality of the preceding description of the invention.

### EXAMPLES

### Example 1

Supplement blocks were prepared with components shown in Table 1 by mixing the ingredients for example, in a concrete mixer, for about 3 minutes and pouring into 30 kg mesh bags.

TABLE 1

| Component | Std | F1 | F2 | F3 | F4 | F5 | F6 | F7 | F8 |
|---|---|---|---|---|---|---|---|---|---|
| Kynofos ® (kg) | 100 | 100 | 100 | 100 | 100 | 100 | 100 | 100 | 100 |
| CMS granules (kg) | 800 | 600 | 500 | 700 | 600 | 500 | 400 | 600 | 500 |
| Seiko-Flow ® | 200 | 200 | 200 | 200 | 200 | 200 | 200 | 200 | 200 |
| surfactant (mL) | | | | | | | | | |
| Magna Pac ® (kg) | 0 | 0 | 0 | 0 | 0 | 0 | 0 | 200 | 300 |
| Corn (kg) | 0 | 200 | 300 | 0 | 0 | 0 | 0 | 0 | 0 |
| Sorghum Syrup (kg) | 0 | 100 | 100 | 100 | 100 | 100 | 100 | 100 | 100 |
| Chip meal (kg) | 0 | 0 | 0 | 100 | 200 | 300 | 400 | 0 | 0 |
| Water (kg) | 100 | 0 | 0 | 0 | 0 | 0 | 0 | 0 | 0 |

Analysis of crude protein, true protein, phosphorus, calcium and water as well as hardness of the block was measured with a CF Durometer with a force of 9.11 kgf. The results are shown in Table 2.

TABLE 2

| Analysis | Std | F1 | F2 | F3 | F4 | F5 | F6 | F7 | F8 |
|---|---|---|---|---|---|---|---|---|---|
| Crude protein | 52% | 41% | 36% | 47% | 41% | 36% | 30% | 40% | 33% |
| True protein | 16% | 15% | 14% | 15% | 14% | 13% | 12% | 13% | 11% |
| Phosphorous | 2% | 2% | 2% | 2% | 2% | 2% | 2% | 2% | 2% |
| Calcium | 3% | 3% | 3% | 3% | 3% | 3% | 3% | 3% | 3% |
| Moisture | 12% | 14% | 14% | 12% | 11% | 11% | 11% | 11% | 10% |
| ME as MJ/kg | 4.11 | 5.8 | 6.7 | 5.3 | 6.4 | 7.6 | 8.8 | 10.9 | 14.2 |
| Hardness | 95 | 90 | 90 | 90 | 90 | 90 | 90 | 88 | 88 |

### Example 2

Supplement blocks were prepared by mixing 100 kg Kynofos®, 800 kg CMS granules, 100 kg water and Seiko-Flow® surfactant (200 mL/1000 kg). The components were mixed in a concrete mixer for 3 minutes. The mixture was shovelled into plastic mesh sacks and stacked in a shed. After 2 days the hardness of the blocks was assessed using a CF Durometer with a force of 9.11 kgf. The blocks had a hardness of 90.

### Example 3

The mixture described in Example 2 was prepared and poured into a conventional dry press with a ram rated at 2000 psi. The press was used to apply 1000 psi pressure for 3 seconds. The block was removed from the press and the hardness measured using a CF Durometer with a force of 9.11 kgf. The block had a hardness of 95.

### Example 4

A supplement block containing a non-protein nitrogen source was prepared by mixing 90 kg Kynofos® or Biofos®, 750 kg CMS granules, 130 kg urea, 1 kg Selko-Flow® surfactant and 29 kg water. The mixing was achieved with two minutes mixing in a BAMA mixer.

### Example 5

A supplement block containing a non-protein nitrogen source was prepared by mixing 90 kg Kynofos® or Biofos®, 600 kg CMS granules, 300 kg biuret, 29 kg water and 1 kg Seiko-Flow® surfactant. The mixing was achieved with two minutes mixing in a BAMA mixer.

1. A solid animal supplement block comprising
i) Condensed Molasses Solubles (CMS) in solid form, wherein the amount of CMS in the supplement block is at least 41.6% w/w,
ii) a source of phosphorus, and
iii) a liquid source.

2. The solid animal supplement block according to claim 1 wherein the crude protein content of the CMS is ≧40% w/w of the CMS composition.

3.-5. (canceled)

6. The solid animal supplement block according to claim 1 wherein the CMS comprises trace minerals selected from potassium and/or sulfur.

7. The solid animal supplement block according to claim 1 wherein the CMS is derived from the fermentation of molasses to produce glutamic acid.

8. The solid animal supplement block according to claim 1 wherein the CMS comprises about 66% to 93.5% w/w of the block.

9. (canceled)

10. The solid animal supplement block according to claim 1 wherein the source of phosphorus comprises a monosodium phosphate, monocalcium phosphate, monodicalcium phosphate, dicalcium phosphate dihydrate, dicalcium phosphate anhydrous or tricalcium phosphate.

11. (canceled)

12. The solid animal supplement block according to claim 1 wherein the source of phosphorus comprises about 3.7% to about 16.5% w/w of the block.

13. (canceled)

14. The solid animal supplement block according to claim 1 wherein the liquid source is water or a syrup.

15. (canceled)

16. The solid animal supplement block according to claim 1 wherein the liquid source comprises about 3% to about 16.5% w/w of the block.

17. (canceled)

18. The solid animal supplement block according to claim 1 further comprising one or more of a surfactant, a further nutritional supplement, a rumen modifier and an anti-methanogenic compound.

19. The solid animal supplement block according to claim 18 wherein the surfactant is a molasses surfactant.

20. The solid animal supplement block according to claim 18 wherein the surfactant comprises about 0.15% to about 0.7% w/w of the block.

21. (canceled)

22. (canceled)

23. The solid animal supplement block according to claim 18 wherein the further nutritional component is selected from grain, starch meal, protein meal, a non-protein nitrogen source and solid fats.

24. The solid animal supplement block according to claim 18 wherein the further nutritional component comprises about 3% to about 7% of the block composition.

25. (canceled)

26. The solid animal supplement block according to claim 18 wherein the rumen modifier is selected from monensin, salinomycin and lasalocid sodium.

27. The solid animal supplement block according to claim 1 having one or more of the following features:
i) the block is moulded into a shape that is stackable;
ii) the block has a centrally located aperture extending through the block; and
iii) the block has markings to determine extent of consumption.

28. (canceled)

29. The solid animal supplement block according to claim 27 wherein the top surface of the feed block has a sloping depression encircling the entry into the aperture.

30. (canceled)

31. A process for making a solid animal supplement block comprising the steps of:
i) adding solid CMS in an amount of at least 41.6% w/w of the supplement block, a source of phosphorus and a liquid source to a mixing container;
ii) mixing the components for a time sufficient to obtain homogenous wetting of the dry components;
iii) transferring the mixture obtained in step ii) into a mould; and
iv) allowing the mixture to harden.

32. The process according to claim 31 wherein pressure is applied to the mould.

33. The process according to claim 32 wherein the pressure applied is equivalent to the weight of the block being prepared.

34. (canceled)

35. The process according to claim 32 wherein the pressure applied is ≦1000 psi.

36. (canceled)

37. The process according to claim 31 further comprising a surfactant and/or further additives added in step i).

38. (canceled)

39. The process according to claim 31 wherein steps i) and ii) occur simultaneously.
